(19) United States
(12) Patent Application Publication
(10) Pub. No.: US 2005/0166367 A1
(43) Pub. Date: Aug. 4, 2005

(54) Window egress assistance handle

(76) Inventor: Gregory Lawler, Coppell, TX (US)

Correspondence Address: Gregory Lawler, 723 Hawk Ln., Coppell, TX, 75019, US

(21) Appl. No.: 11/047,978

(22) Filed: Feb. 1, 2005

Related U.S. Application Data
(60) Provisional application No. 60/541,106, filed on Feb. 2, 2004.

(51) Int. Cl. E05C 3/06

(52) U.S. Cl. 16/444

(57) ABSTRACT

A window egress assistance handle having a base, at least one finger grip with two legs, multiple offset orifice fixation ports for receiving multiple securing devices such as set screws or thumb screws, and a base midline grooved channel receiver. To temporarily install and use the handle, the handle is positioned to envelope an integrated extruded window sash lift in the grooved channel receiver, and the securing devices disposed in the multiple offset fixation port are engaged to create a binding compressive force upon enveloped sash lift. The window can then be lifted or slid by applying force to the finger grips. The handle can be adjusted to the user's strength, size, and dimensions, and installed and removed without use of tools or creating permanent damage to the framework of the window.

### CROSS-REFERENCE TO RELATED APPLICATIONS

Priority is claimed for this patent application to U.S. Provisional Patent Application No. 60,541,106, filed Feb. 2, 2004, by Gregory Lawler.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

U.S. Provisional Patent Application No. 60,541,106, is hereby incorporated by reference in its entirety, including figures.

### BACKGROUND OF THE INVENTION

1. Field of The Invention

This invention relates to window opening assistance devices for anyone needing assistance opening a window, especially in emergency situations.

2. Background of the Invention

Windows in dwellings can become difficult to open. This is due to post construction changes in a structure. Changes that frequently occur are shrinking and swelling of the window unit due to exposure of extreme elements of weather such as heat, cold, dry or moist atmospheres. Over time many structures may experience shifting due to ground movement and gravity. Dirt deposits collect due to poor maintenance. These post construction changes can cause the window to become difficult to open.

Many windows integrate a dedicated lift area. However, many times this areas is not sufficient regarding the size and strength regarding the occupant desiring to open the window.

This clearly puts occupants at great disadvantage when needing to make emergency exit. This is evident by the fact that there are 2 ways out of a home in the event of fires. Yet 800 kids under the age of 9 die each year in home fires. The problem of window egress is clear and can be addressed properly by the use of my invention. Proper education and encouragement by professional and volunteer firefighters are only available after engineering process is complete. Our invention must be first available.

It is estimated by the firefighting profession that 60-90% of home dwellers do not practice fire drills. To highlight the importance of our invention which could save many lives. After Sep. 11, 2001, the Department of Homeland Security cited that terrorists could threaten soft targets. This included family dwellings. As firefighters, we have a response obligation of duty to protect America from harm at every level concerning safety. Most important problem our invention will solve is allowing us as firefighters to give kids a solid answer to their most common question, which is “What do I do if the window won't open during a fire and that is my only way out?” . Today, firefighters across the country answer “Do whatever it takes.” This is not a good plan.

Window lift areas are usually integrated into the framework of the window by manufacturers. Historically, these are small and present a challenge to the fingertip strengths of many uses, especially the young and others who have dexterity deficits. Additionally handles may be obtained when minimal or no integrated lift design exists. These additional handles require skill to ensure proper mounting. These handles are usually screwed into the framework and the margin for error by the untrained installer can range from crooked handles to unrepairable holes in the framework of the window. Placement errors can cause the handle to become less effective. Placement issues are of great importance to the end user. Other handles do not allow movement or adjustment to meet the optimum position for the user whose needs may change. Once again, without leaving unsightly holes when adjusting optimum leverage is required during the lifting, pushing, or pulling action during sliding operation due to the physical changes of the user. If people of different sizes change living quarters, it requires possible different position placement in order to optimize leverage. Additionally, when one moves from one dwelling to another, to remove this device again leaves unsightly holes in the window framework.

### SUMMARY OF THE INVENTION

My invention is a rigid handle which attaches to an existing window lift. The handle provides greater surface area for grasping, therefore allowing the user to leverage any additional available strength for the purpose of assistance in opening and closing operation of the window.

### BRIEF DESCRIPTION OF THE DRAWINGS

The present embodiment should be more fully understood when the written description is considered in conjunction with the drawings contained herein, wherein:

FIG. 1 shows a front view of the entire window egress assistance handle (1) with a base (2), a finger grip (3), two legs (4) and multiple offset orifice ports for various securing devices (6).

FIG. 2 shows a side view of the window egress assistance handle (1) with a base (2), the base midline grooved channel receiver (5), multiple offset orifice fixation port for various securing devices (6) with set screws (7).

FIG. 3 provides a side view of the window egress assistance handle (1) positioned for attachment by placing the base midline grooved channel receiver (5) as to envelope the integrated extruded sash lift (8) that is part of the bottom rail (11) which is attached to a side window stile (9) which holds the window pane glass (10).

FIG. 4 includes a window frame (12) showing window stiles (9) with a bottom rail (11) and a top rail (not shown) that houses a windowpane glass (10). The bottom rail(l 1) has an integrated extruded sash lift (8) which shows two window egress assistance handles (1) attached.

FIG. 5 shows a partial view of a window stile (9), window glass pane (10), and a bottom rail (11). A bottom view of the cutaway window egress assistance handle (1) positioned with the base midline grooved receiver (5) enveloping the integrated extruded sash lift (8) temporarily secured by set screws (7).

FIG. 6 shows a person (13) using the window egress assistance handles (1) after mounting.

### DETAILED DESCRIPTION OF THE INVENTION

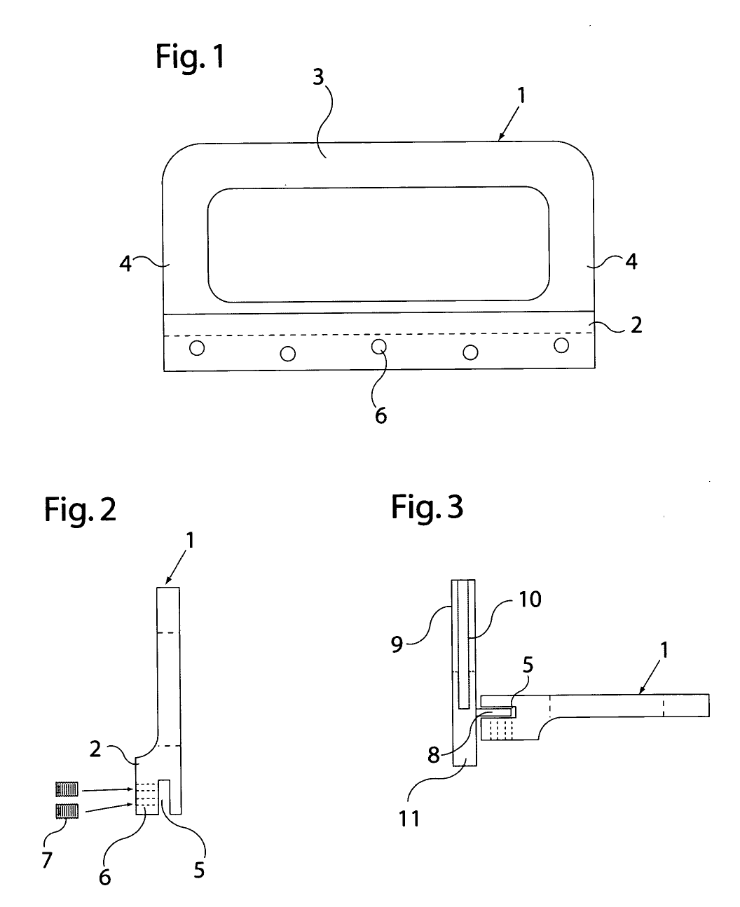

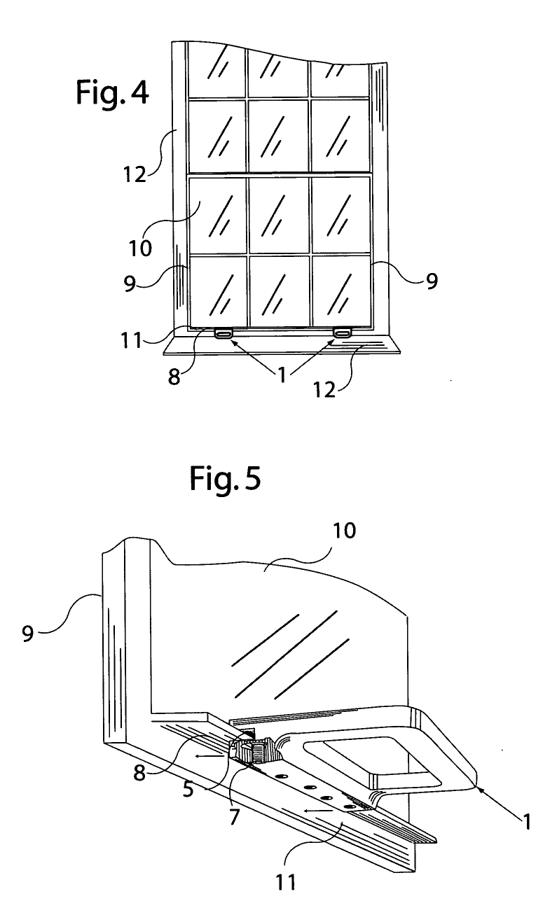

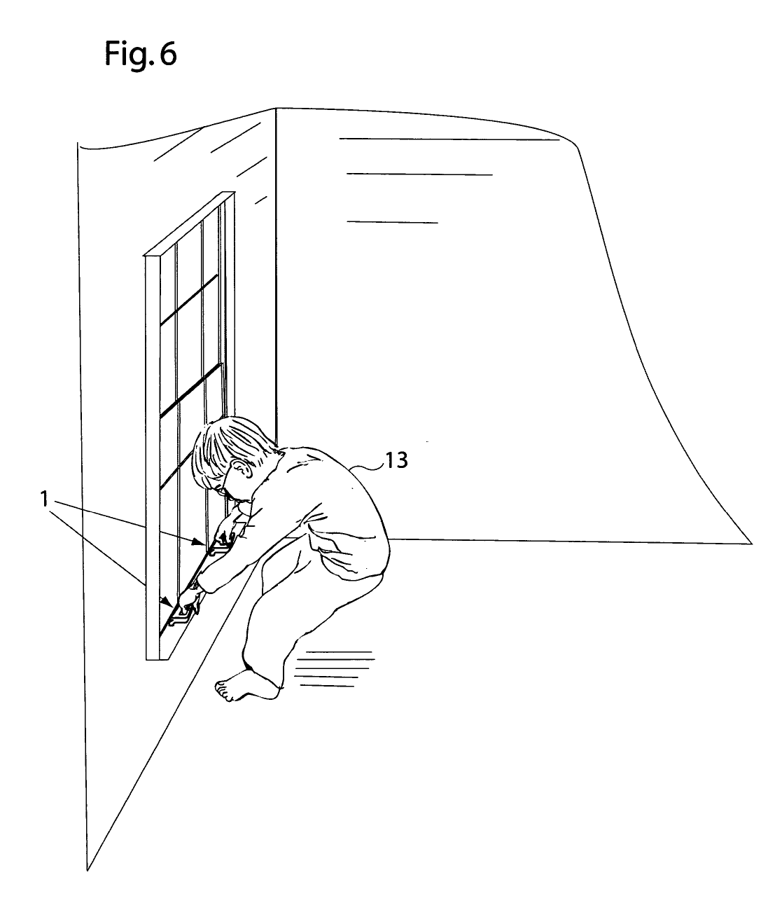

As shown in FIG. 1, a window egress assistance handle (1) made of milled rigid metal, which could also be made as a unitary piece of resilient plastic or likewise comprised of two pieces of rigid metal fastened together to form a compressive force binding both surfaces of the sash lift. The handle includes a base (2), a finger grip (3) with two legs (4), secured by multiple offset orifice fixation ports for various securing devices (6) such as set screws or thumb screws (7) to create a binding compressive force. The based midline grooved channel receiver (5) is shown throughout FIG. 2 and FIG. 3. A window stile (9) with window pane glass (10) and a bottom rail (11) with an integrated extruded window sash lift (8) that receives the window egress assistance handle (1) by enveloping the base midline grooved channel receiver (5). Two handles (1) are temporarily mounted on an integrated extruded window sash lift (8) as shown in FIG. 4. FIG. 5 is a bottom view of FIG. 3. FIG. 6 shows a person (13) using that window egress assistance handles (1) after mounting.

To use our window egress assistance handle invention, locate the subject window upper or lower sash lift for vertical windows. The device is mounted by placing the base midline grooved channel receiver (5) into position as to envelope the sash lift 98) which is then held securely in place temporarily by use of set screws (7) which are place in the multiple offset orifice fixation ports (6). The handles when used in the vertical operations should be mounted equidistant from the ends of the window and inline with the user's shoulders.

To use our window egress assistance handle (1) invention, locate the sash lift (8) on either the left or right side for horizontal windows. The device is mounted by placing the base midline grooved channel receiver (5) into the position as to envelope the sash lift (8) which is then held securely in place temporarily by use of set screws which are placed in the multiple offset orifice fixation ports (6). The handle (1) when used in the horizontal operation should be mounted four inches above the interior sill or even with the user's shoulder while standing.

The handle (1) assists the user in opening the window after the window is unlocked. The user grasps the handle (1) and lifts, pushes or pulls. The handle (1) provides greater surface area for grasping, allowing the user to leverage any additional available strength for the purpose of assistance in opening and closing operation of the window, especially in emergent situations.

1. A window egress assistance handle comprising:
a base (2) and at least one finger grip (3) with two legs;
multiple offset orifice fixation ports for receiving multiple securing devices;
a base midline grooved channel receiver (5) configured envelope an integrated extruded window sash lift (8); and
multiple securing devices disposed in said multiple offset fixation ports, engaged to create a binding compressive force upon said enveloped sash lift, thereby temporarily mounting said handle to said window sash lift.

2. The device as set forth in claim 1 wherein said base is comprised of milled rigid metal.

3. The device as set forth in claim 1 wherein said base is comprised of a unitary piece of resilient plastic.

4. The device as set forth in claim 1 wherein said base is comprised of two pieces of rigid metal fastened together to form a compressive force binding both surfaces of the sash lift.

5. The device as set forth in claim 1 wherein said securing devices comprise at least one set screw.

6. The device as set forth in claim 1 wherein said securing devices comprise at least one thumb screws.
